(19) United States
(12) Patent Application Publication
(10) Pub. No.: US 2005/0134817 A1
(43) Pub. Date: Jun. 23, 2005

(54) Liquid immersion type exposure apparatus

(76) Inventor: Takashi Nakamura, Tokyo (JP)

Correspondence Address: MORGAN & FINNEGAN, L.L.P., 3 WORLD FINANCIAL CENTER, NEW YORK, NY, 10281-2101, US

(21) Appl. No.: 10/877,142

(22) Filed: Jun. 24, 2004

(30) Foreign Application Priority Data
Jun. 25, 2003 (JP) 181260/2003(PAT.)

(51) Int. Cl. G03B 27/42

(52) U.S. Cl. 355/53

(57) ABSTRACT

Disclosed is a liquid immersion type exposure apparatus which is applicable not only to a liquid immersion exposure apparatus of the type that an exposure substrate as a whole is immersed in a liquid vessel but also to a liquid immersion exposure apparatus of the type that a liquid medium is held in a portion between the exposure substrate and a termination end portion of a projection optical system, and by which production of bubbles can be reduced without interference with exposure. In one preferred from, a degassing system for removing a gas dissolved in the liquid is provided in a liquid medium supplying path and/or a liquid medium collecting path, by which production of bubbles is reduced sufficiently.

### FIELD OF THE INVENTION AND RELATED ART

This invention relates to a projection exposure apparatus to be used in a lithographic process for manufacture of devices such as semiconductor integrated circuit, image pickup device (e.g. CCD), liquid crystal display device, or thin-film magnetic head, for example. More particularly, the invention concerns a liquid immersion type exposure apparatus in which exposure is carried out through a liquid medium placed at least in a portion of a light path between a projection optical system and a substrate to be exposed.

The exposure wavelength has been made shorter and shorter to meet improvements in the required resolution of exposure apparatuses. Since such shortening of the exposure wavelength leads to difficulties in developing and producing lens materials which are transparent with respect to that wavelength, it raises the cost of the projection optical system. Therefore, recent exposure apparatuses are becoming expensive.

In consideration of these inconveniences, liquid immersion type exposure apparatuses have been proposed as an exposure apparatus in which, while using a similar projection exposure system as used conventionally, the wavelength of light upon the surface of a substrate to be exposed is substantially shortened to thereby increase the resolution.

In such liquid immersion type exposure apparatus, at least a portion between a substrate and a free end portion of an optical element of a projection optical system, closest to the substrate, that is, the trailing end portion of the projection optical system, is filled with a liquid medium. Where the liquid medium has a refractive index N, the wavelength of exposure light within the liquid medium is 1/N of that within the air. Therefore, it is possible to increase the resolution without changing the structure of a conventional exposure apparatus largely.

For example, Japanese Laid-Open Patent Application No. 57-153433 proposes an apparatus having a structure that a liquid is discharged from a nozzle provided near a free end of a lens to assure that the liquid is kept only between the lens and an exposure substrate.

Also, Published International Application No. WO 99/49504 shows a liquid immersion type exposure apparatus in which, when a substrate is moved in a predetermined direction, a predetermined liquid is caused to flow along the movement direction of the substrate so as to assure that the liquid fills the space between the surface of the substrate and a free end of an optical element of a projection optical system, facing to the substrate side.

Furthermore, Japanese Laid-Open Patent Application No. 6-124873 proposes an apparatus of the structure that the exposure substrate as a whole is immersed in a liquid.

In liquid immersion type exposure apparatuses, mixture of bubbles into a liquid filling the interspace between an exposure substrate and a termination end portion of a projection optical system must be avoided. This is because exposure errors are easily caused by extraordinary refraction and reflection of light by the bubbles, not only when the bubbles in the liquid are adhered to the substrate but also when the bubbles are floating in the vicinity of the exposure substrate.

Generally, it is known that, in an environment of normal atmosphere and a temperature of 0° C., airs of milliliters may dissolve into one litter of water. The amount of dissolution of the gas decreases when the temperature of the liquid rises or the pressure decreases. Therefore, if the temperature of the liquid is raised by various heat sources inside the exposure apparatus, airs having been dissolved in the liquid may emerge as bubbles. Furthermore, when the liquid flows through a flowpassage, the pressure may decrease locally at a bent portion or the like and, in that occasion, bubbles may come at such bent portion.

The aforementioned Japanese Laid-Open Patent Application No. 6-124873 discloses a method of degassing a liquid, wherein a liquid vessel for immersing an exposure substrate as a whole in a liquid is provided and the liquid vessel is vacuum-evacuated for the degassing. With this method, however, there is a possibility that bubbles are produced in the path of exposure light and, therefore, the degassing can not be performed during the exposure. Further, it is necessary to take a sufficient time to remove bubbles produced during the degassing process. On the other hand, in the liquid immersion type exposure apparatus wherein a liquid is held in a portion of a space between an exposure substrate and a termination end portion of a projection optical system, such as the exposure apparatus disclosed in the aforementioned Published International Application No. WO 99/49504, the apparatus has no liquid vessel and, accordingly, the degassing process based on vacuum evacuation is inherently unattainable.

It is therefore desirable to provide measures for reducing bubble production without interference with the exposure process, which measures can be applied not only to a liquid immersion exposure apparatus of the type that an exposure substrate as a whole is immersed in a liquid vessel but also to a liquid immersion exposure apparatus of the type that a liquid is held in a portion between an exposure substrate and a termination end portion of a projection optical system.

### SUMMARY OF THE INVENTION

It is accordingly an object of the present invention to provide a liquid immersion type exposure apparatus by which production of bubbles between a projection optical system and a wafer can be reduced sufficiently.

It is another object of the present invention to provide a high-performance device manufacturing method using such exposure apparatus.

In accordance with an aspect of the present invention, there is provided a liquid immersion type exposure apparatus, comprising: a projection optical system for projecting a pattern of a mask onto a substrate; and a liquid supplying and collecting system for supplying a liquid medium to at least a portion of a space between said projection optical system and the substrate and for collecting the supplied liquid medium, wherein said liquid supplying and collecting system includes degassing means for degassing the liquid medium, said degassing means being provided in a path for supplying the liquid medium and/or a path for collecting the liquid medium.

In accordance with another aspect of the present invention, there is provided a liquid immersion type exposure apparatus, comprising: a projection optical system for projecting a pattern of a mask onto a substrate; and a liquid supplying and collecting system for supplying a liquid medium to at least a portion of a space between said projection optical system and the substrate and for collecting the supplied liquid medium, wherein the path for supplying the liquid medium and the path for collecting the liquid medium, of said liquid supplying and collecting system, are interchangeable.

In accordance with a further aspect of the present invention, there is provided a liquid immersion type exposure apparatus, comprising: a projection optical system for projecting a pattern of a mask onto a substrate; and a liquid supplying and collecting system for supplying a liquid medium to at least a portion of a space between said projection optical system and the substrate and for collecting the supplied liquid medium, wherein the path for supplying the liquid medium and/or the path for collecting the liquid medium, of said liquid supplying and collecting system, extends through (or embedded in) a barrel of said projection optical system or an inside of a termination end portion of said projection optical system.

In accordance with a yet further aspect of the present invention, there is provided a device manufacturing method, comprising the steps of: exposing a substrate by use of a liquid immersion type exposure apparatus as recited above; and developing the exposed substrate.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of a general structure of a liquid immersion type exposure apparatus according to an embodiment of the present invention.

FIG. 2 is a flow chart for explaining device manufacturing processes.

FIG. 3 is a flow chart for explaining details of a wafer process shown in FIG. 2.

### DESCRIPTION OF THE PREFERRED EMBODIMENTS

Preferred embodiments of the present invention will now be described with reference to the attached drawings.

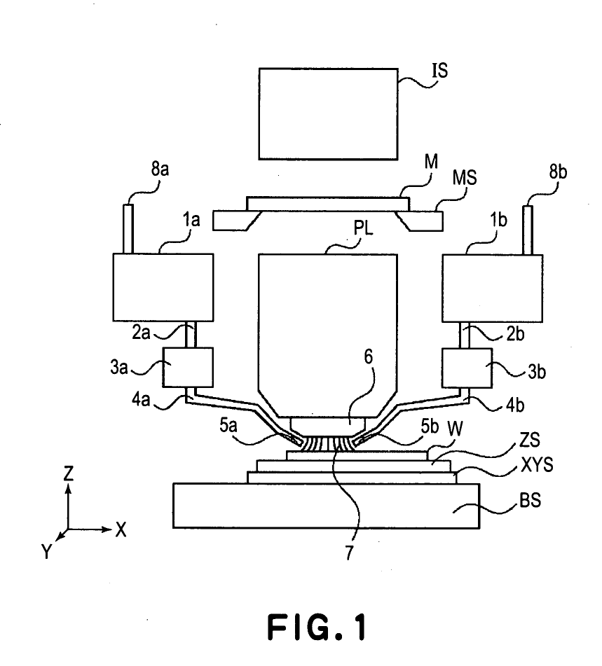

FIG. 1 illustrates a general structure of a liquid immersion type exposure apparatus according to an embodiment of the present invention. A longitudinal direction (Z direction) in the drawing corresponds to a vertical (gravity) direction.

Exposure light from an illumination device IS illuminates a mask or reticle M (which is an original), and a pattern of the mask M is transferred, while being reduced, by a projection optical system PL to a wafer (or a glass plate, for example) W (which is a photosensitive substrate), being coated with a resist. The illumination device IS comprises a light source (e.g. ArF excimer laser having a wavelength of about 193 nm or KrF excimer laser having a wavelength of about 248 nm), and an illumination system for illuminating the mask with light from such light source.

The liquid immersion type exposure apparatus of this embodiment is what is called a “step-and-scan exposure apparatus”, and the exposure is carried out while the mask M and the wafer W are scanned synchronously.

The mask M is held on a mask stage MS (mask holding means), and its position is adjusted thereon. A termination end portion 6 is a part of a projection optical system PL, and it may be a lens (optical element), for example. The termination end portion is a component of the projection optical system, which is disposed closest to the wafer. The bottom surface of the projection optical system termination portion 6, that is, the surface disposed opposed to the wafer W, is a flat surface. The position of the wafer W with respect to horizontal directions is adjusted by means of an X-Y stage XYS, and the position thereof with respect to vertical directions is adjusted by means of a Z stage ZS. The Z stage ZS is mounted on the X-Y stage XYS. Denoted at BS is a precision base table that supports the X-Y stage XYS.

Denoted at 1a is a liquid supplying and collecting system which receives the supply of pure water from a water supply pipe 8a. The liquid supplying and collecting system is connected to a degassing system 3a through a joint pipe 2a. The water supply pipe 8a is connected to a pure water producing equipment, not shown. Gases dissolved in a liquid medium flowing through the degassing system 3a are removed in accordance with a method which will be described later. A liquid supplying and collecting pipe 4a is connected to the degassing system 3a. There is a nozzle 5a formed at a tip end of the liquid supplying and collecting pipe 4a. The tip end of the nozzle 5a is disposed close to the bottom surface edge of the termination end portion 6 of the projection exposure system.

The liquid medium discharged from the nozzle 5a fills the space between the wafer W and the projection optical system termination end portion 6, and a liquid film 7 is formed there. The nozzle 5a can operate as required to suck up the liquid medium that forms the liquid film 7. The liquid discharging and the liquid suction described above are controlled through the liquid supplying and collecting system 1a.

The liquid film 7 should transmit the exposure light with minimum absorption. Also, it should not abrade a resist material applied to the wafer W. For these reasons, pure water is used as the liquid medium.

The exposure apparatus further comprises a liquid supplying and collecting system 1b, a joint pipe 2b, a degassing system 3b, a liquid supplying and collecting pipe 4b, a nozzle 5b and a water supply pipe 8b, all of which have a similar function as of the liquid supplying and collecting system 1a, the joint pipe 2a, the degassing system 3a, the liquid supplying and collecting pipe 4a, the nozzle 5a and the water supply pipe 8a, respectively. The tip end of the nozzle 5b is disposed at a side of the projection optical system termination end portion 6, remote from the nozzle 5a.

In FIG. 1, when the wafer W is moved rightwardly, the liquid supplying and collecting system 1a expels a liquid medium reserved therein, by use of a pump. The liquid medium is supplied to the degassing system 3a through the joint pipe 2a and, after gasses are removed there, the liquid medium is supplied to the liquid supplying and collecting pipe 4a. The liquid medium is then discharged from the nozzle 5a onto the wafer W, such that the liquid film 7 can be maintained there. On the other hand, following the motion of the wafer W, the right-hand side end portion of the liquid film 7 is undesirably going to be dislocated off the bottom face area of the tip end portion 6 of the projection optical system. However, this can be prevented by sucking the liquid medium by use of the nozzle 5b. The liquid medium thus sucked through the nozzle 5b is sent to the degassing system 3b via the liquid supplying and collecting pipe 4b. Although the amount of liquid medium that has formed the liquid film 7 is very small, since it has been actually in contact with the atmosphere, preferably it should be degassed through the degassing system 3b. The thus degassed liquid medium is reserved into the liquid supplying and collecting system 1b through the join pipe 2b.

In FIG. 1, when the wafer W is moved leftwardly, the above-described operations are carried out inversely (in the sense of right and left). Namely, in the liquid immersion type exposure apparatus of this embodiment, the path for supplying a liquid medium and the path for collecting the liquid medium are made interchangeable, and the paths can be interchanged to assure that the liquid medium is supplied in the movement direction of the wafer W.

If the liquid suction operation and the liquid discharging operation are repeated at a single nozzle (5a or 5b), there is a possibility that the sucked liquid medium is discharged again without reaching the degassing system (3a or 3b). Although this is not preferable, it does not raise a critical problem if the time the liquid contacts the atmosphere is very short.

Now, the degassing systems 3a and 3b will be described. Generally, the amount of gas that can be dissolved in a liquid decreases with a pressure decrease and a temperature rise. In consideration of this, practical degassing systems utilize pressure change or temperature change, or both of them. As a simplest method, a liquid is introduced into a chamber and the pressure thereof is reduced by vacuum attraction. This method involves an inconvenience that the liquid can not be degassed continuously. Alternatively, there is a method for heating a liquid in a chamber or a method for oscillating the liquid by ultrasonic. These methods however involve a similar disadvantage that continuous degassing is unattainable. As a continuous degassing method, there has been proposed a method in which a gas-liquid separating film tube is placed in a reduced pressure ambience and a liquid is fed through the tube. The gas-liquid separating film is a film that allows permeation of gas but it does not allow permeation of liquid. As an example, a degassing system that uses a non-porous gas-liquid separating film tube has been practically developed. Any one of the degassing methods described above may be used to provide the degassing systems 3a and 3b of this embodiment.

In FIG. 1, the nozzles 5a and 5b are illustrated as being spaced apart from the termination end portion 6 of the projection optical system. However, it is considered that the liquid film 7 should have a thickness of about 0.1 mm, in order to obtain a good exposure precision. For this reason, practically, the nozzles 5a and 5b have to be placed very close to the bottom face edge of the projection optical system termination end portion 6. To this end, as an example, the nozzles 5a and 5b may be embedded in the projection optical system termination end portion 6 or inside the barrel portion of the projection optical system adjacent the end portion, so that the liquid supplying path and/or the liquid collecting path extends therethrough.

In the embodiment described above, the liquid is held only between the exposure substrate and the projection optical system termination end portion. However, it should be noted that the present invention is applicable to any one of a method in which a liquid is held only between an exposure substrate and a projection optical system termination end portion and a method in which an exposure substrate as a whole is immersed in a liquid.

Further, in the embodiment described above, each of the degassing systems 3a and 3b (degassing means) is disposed just before an associated nozzle 5a or 5b. This is a structure that liquid discharging and liquid suction are performed though one and the same nozzle, ensuring that the sucked liquid can be degassed immediately. However, where the liquid discharging and liquid suction are performed through separate nozzles and the liquid is circulated, or if the liquid once discharged is not used again, it is no more necessary to place the degassing means at the liquid suction side path.

Furthermore, the present invention can be applied to a liquid immersion exposure apparatus of the type that an exposure substrate as a whole is immersed in a liquid vessel, with a modification that the degassing means is disposed at any desired position in the path of supplying a liquid medium into the liquid vessel.

It should be noted here that, in this embodiment, where F2 laser having a wavelength of about 157 nm, for example, is used as a light source, regarding the liquid medium, a fluorine series inactive liquid, that is, a safe liquid being chemically stable and having a high transmissivity to exposure light, may be used.

Although this embodiment concerns a step-and-scan type exposure apparatus, the present invention is applicable also to a step-and-repeat type exposure apparatus, called a stepper.

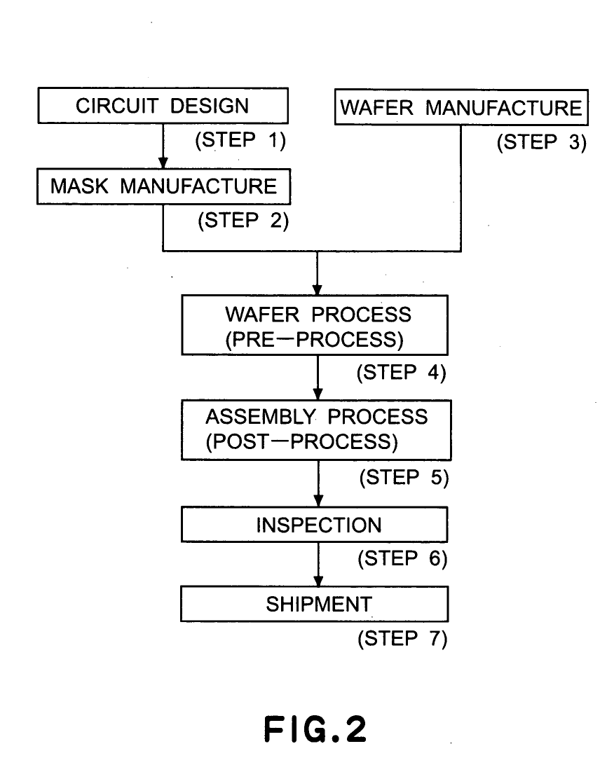

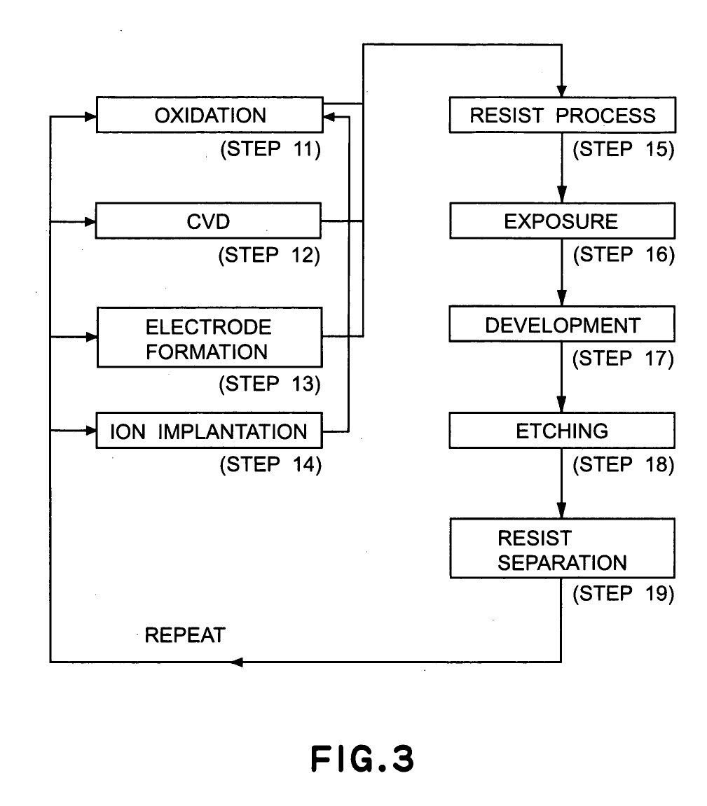

Next, referring to FIGS. 2 and 3, an embodiment of a device manufacturing method which uses an exposure apparatus described above, will be explained.

FIG. 2 is a flow chart for explaining the procedure of manufacturing various microdevices such as semiconductor chips (e.g., ICs or LSIs), liquid crystal panels, or CCDs, for example. Step 1 is a design process for designing a circuit of a semiconductor device. Step 2 is a process for making a mask on the basis of the circuit pattern design. Step 3 is a process for preparing a wafer by using a material such as silicon, for example. Step 4 is a wafer process which is called a pre-process wherein, by using the thus prepared mask and wafer, a circuit is formed on the wafer in practice, in accordance with lithography. Step 5 subsequent to this is an assembling step which is called a post-process wherein the wafer having been processed at step 4 is formed into semiconductor chips. This step includes an assembling (dicing and bonding) process and a packaging (chip sealing) process. Step 6 is an inspection step wherein an operation check, a durability check an so on, for the semiconductor devices produced by step 5, are carried out. With these processes, semiconductor devices are produced, and they are shipped (step 7).

FIG. 3 is a flow chart for explaining details of the wafer process. Step 11 is an oxidation process for oxidizing the surface of a wafer. Step 12 is a CVD process for forming an insulating film on the wafer surface. Step 13 is an electrode forming process for forming electrodes upon the wafer by vapor deposition. Step 14 is an ion implanting process for implanting ions to the wafer. Step 15 is a resist process for applying a resist (photosensitive material) to the wafer. Step 16 is an exposure process for printing, by exposure, the circuit pattern of the mask on the wafer through the exposure apparatus described above. Step 17 is a developing process for developing the exposed wafer. Step 18 is an etching process for removing portions other than the developed resist image. Step 19 is a resist separation process for separating the resist material remaining on the wafer after being subjected to the etching process. By repeating these processes, circuit patterns are superposedly formed on the wafer.

With these processes, high density microdevices can be manufactured.

The entire disclosure of Japanese Patent Application No. 2003-181260 filed in Japan on Jun. 25, 2003, including the claims, specification, drawings and abstract, is incorporated herein by reference in its entirety.

While the invention has been described with reference to the structures disclosed herein, it is not confined to the details set forth and this application is intended to cover such modifications or changes as may come within the purposes of the improvements or the scope of the following claims.

1. A liquid immersion type exposure apparatus, comprising:
a projection optical system for projecting a pattern of a mask onto a substrate; and
a liquid supplying and collecting system for supplying a liquid medium to at least a portion of a space between said projection optical system and the substrate and for collecting the supplied liquid medium,
wherein said liquid supplying and collecting system includes degassing means for degassing the liquid medium, said degassing means being provided in a path for supplying the liquid medium and/or a path for collecting the liquid medium.

2. An apparatus according to claim 1, wherein the path for supplying the liquid medium and the path for collecting the liquid medium, of said liquid supplying and collecting system, are interchangeable.

3. An apparatus according to claim 1, wherein the path for supplying the liquid medium and/or the path for collecting the liquid medium, of said liquid supplying and collecting system, extends through a barrel of said projection optical system or an inside of a termination end portion of said projection optical system.

4. An apparatus according to claim 2, wherein the path for supplying the liquid medium and/or the path for collecting the liquid medium, of said liquid supplying and collecting system, extends through a barrel of said projection optical system or an inside of a termination end portion of said projection optical system.

5. A liquid immersion type exposure apparatus, comprising:
a projection optical system for projecting a pattern of a mask onto a substrate; and
a liquid supplying and collecting system for supplying a liquid medium to at least a portion of a space between said projection optical system and the substrate and for collecting the supplied liquid medium,
wherein the path for supplying the liquid medium and the path for collecting the liquid medium, of said liquid supplying and collecting system, are interchangeable.

6. An apparatus according to claim 5, wherein the path for supplying the liquid medium and the path for collecting the liquid medium, are interchanged in accordance with a movement direction of the substrate.

7. An apparatus according to claim 5, wherein the path for supplying the liquid medium and/or the path for collecting the liquid medium, of said liquid supplying and collecting system, extends through a barrel of said projection optical system or an inside of a termination end portion of said projection optical system.

8. A liquid immersion type exposure apparatus, comprising:
a projection optical system for projecting a pattern of a mask onto a substrate; and
a liquid supplying and collecting system for supplying a liquid medium to at least a portion of a space between said projection optical system and the substrate and for collecting the supplied liquid medium,
wherein the path for supplying the liquid medium and/or the path for collecting the liquid medium, of said liquid supplying and collecting system, extends through a barrel of said projection optical system or an inside of a termination end portion of said projection optical system.

9. An apparatus according to claim 9, wherein the termination end portion of said projection optical system is an optical element of said projection optical system, at the substrate side.

10. A device manufacturing method, comprising the steps of:
exposing a substrate by use of a liquid immersion type exposure apparatus as recited in claim 1; and
developing the exposed substrate.

11. A device manufacturing method, comprising the steps of:
exposing a substrate by use of a liquid immersion type exposure apparatus as recited in claim 5; and
developing the exposed substrate.

12. A device manufacturing method, comprising the steps of:
exposing a substrate by use of a liquid immersion type exposure apparatus as recited in claim 8; and
developing the exposed substrate.
